(19) United States
(12) Patent Application Publication
(10) Pub. No.: US 2023/0224442 A1
(43) Pub. Date: Jul. 13, 2023

(54) METHODS FOR PRODUCING VISUAL IMMERSION EFFECTS FOR AUDIOVISUAL CONTENT

(71) Applicant: CGR CINEMAS, Perigny Cedex (FR)

(72) Inventor: Jérôme DEMOULIN, Perigny Cedex (FR)

(73) Assignee: CGR CINEMAS, Perigny Cedex (FR)

(21) Appl. No.: 18/008,786

(22) PCT Filed: Jun. 14, 2021
(86) PCT No.: PCT/EP2021/065954

§ 371 Date: Dec. 7, 2022

(30) Foreign Application Priority Data
Jun. 18, 2020 (FR) FR2006375

(51) Int. Cl. H04N 9/31; G06T 5/00; G06T 7/194; G06T 7/11; G06T 7/70; G10L 15/18; G10L 25/57

(52) U.S. Cl. CPC H04N 9/3182; G06T 5/002; G06T 7/11; G06T 7/70; G06T 7/194; G10L 15/1815; G10L 25/57; A63J 25/00

(57) ABSTRACT

A method for producing visual immersion effects for audiovisual content and sound content associated with the video image, the method including the steps of extracting a background of a video image from the audiovisual content; selecting an end zone located at one end of the extracted background; determining a semantic state from the sound content associated with the video image, and processing a predefined image in the selected end zone to generate at least one visual frame intended to be displayed in the peripheral field of vision of a viewer while the video image is being projected in the central field of vision of the viewer, the processing of the predefined image being linked to the semantic state determined from the sound content.

### CROSS-REFERENCE TO RELATED APPLICATIONS

This application claims priority to PCT Patent Application Serial No. PCT/EP2021/065954 filed on Jun. 14, 2021, which claims priority to the French Patent Application Serial No. FR2006375 filed Jun. 18, 2020, both of which are incorporated by reference herein.

### BACKGROUND AND SUMMARY

The present invention relates to methods for producing visual immersion effects for audiovisual content such as a film.

Peripheral vision stimulation is one of the main factors promoting a sense of immersion for a viewer placed facing a screen. It is indeed generally accepted that, in order to have the impression of being in an image rather than in front of an image, the visual field of the viewer should be stimulated practically in its entirety. For this purpose, visual frames deduced from the audiovisual content being projected are displayed on either side of a screen at the front so as to also cover the viewer’s peripheral field of view.

Nevertheless, given the specific sensitivities of peripheral vision, particular attention needs to be paid to the content of these visual frames. Peripheral vision is in fact passive and particularly sensitive to contrasts and to movements. Inappropriate peripheral content (having high contrast with respect to what is displayed in the central field of view or involving sudden movement for example) can divert the viewer’s attention from the video image being projected on the screen at the front, thereby reducing, or even cancelling out the immersion effect. The content of these visual frames, which escapes the direct analysis of the viewer, must be defined so as to best improve the viewer’s immersive experience.

By way of prior art, we can consider US2006/268363 which discloses a method which generates in real time the visual frames intended for the screens on the basis of the content broadcast on the screen and the atmosphere of the theater. For this purpose, according to US2006/268363, it is necessary to access the video and audio content to the broadcast.

According to the invention, the visual immersion effects are prepared and constructed upstream of the projection and don’t have to be merged with the content while it is being played out from the media. These effects form a collection allowing creative teams to generate the final contents using a palette of effects. The generation of this palette allows an enormous saving of time in producing content.

US2006/268363 has the following drawbacks that the method according to the present invention does not have including the need for metadata for identifying image elements, such as background (see § [0046] [0047] [0061], or the need to capture the data stream in real time (see § [0044] [0045] [0048] as it is not accessible in the cinematographic operating context and as processing is carried out upstream. Also, this disclosure (see § [0049] - [0052], [0058], [0081] only has use limited to projecting images on physical walls, whereas according to the invention it is possible to feed displays or apparatuses relying on light.

The system according to the present invention makes it possible to display visual content on different media (for example physical panels, or virtual environments in 3D simulation, etc.) by synchronizing in time with encrypted multimedia players without having access to the content being played out. An object of the present invention is to propose visual frames favoring an immersive experience based on peripheral visual perception to the best degree possible. The invention in fact makes it possible to generate the immersive effects upstream of the projection, which cannot be achieved with the methods and apparatuses implemented to date.

Another object of the present invention is to generate, for a given audiovisual content, a library of visual immersion effects allowing the creation of a visual immersion script for the specific content. Another object of the present invention is to be able to automatically generate, for a given film, a visual immersion script intended to stimulate the viewer’s peripheral vision during the projection of the film. To this end, the invention provides, in a first aspect, a method for producing visual immersion effects for audiovisual content integrating a video image and sound content associated with the video image, this method comprising the steps of:
extracting a background from the video image;
selecting a first end region located at a first end of the extracted background;
determining a semantic state of the sound content;
applying a predefined image processing to the selected first end region to generate at least one visual frame intended to be is played in the peripheral field of view of a viewer during the projection of the video image into the central field of view of the viewer, this method being characterized in that the predefined image processing is related to the determined semantic state of the sound content.

Various additional features may be provided, alone or in combination:
the method further includes a step of determining a sound parameter from the sound content, the predefined image processing being related to the sound parameter determined from the sound content;
the sound parameter is chosen from a list comprising a pitch of the sound, a sound duration, a sound intensity, a timbre of the sound, and/or a sound directivity;
the predefined image processing comprises a step of setting the colorimetric ambience of the selected first end region;
the predefined image processing comprises a step of restituting the average colorimetric ambience of the first selected end region;
the predefined image processing comprises a step of changing the brightness of at least one color in the selected first end region;
the predefined image processing comprises a step of applying a blurring effect;
the method further comprises the steps of selecting a second end region located at a second end of the extracted background, the second end being opposite the first end, applying said predefined image processing to the selected second end region;
a plurality of different visual frames integrating said at least one visual frame is generated from the first end region;
the method further comprises the steps of extracting a foreground from the video image; detecting a beam of light in the extracted foreground; determining a direction of the detected beam of light; generating control data for controlling a light source adapted to generate a beam of light in a direction associated with the determined direction;
the method comprises a step of generating a visual immersion script integrating the visual frame;
the visual immersion script further comprises control data;
the control data is interpretable by a script reader in any form be it software, hardware, firmware or a combination of these forms;
the method further comprises a step of adding the visual immersion script to the audiovisual content;
the method further comprises a step of reading out the visual immersion script in a virtual environment in 3D simulation.

In a second aspect, the invention provides a computer program product implemented on a memory medium, capable of being implemented within a computer processing unit and comprising instructions for implementing a method for producing visual immersion effects for audiovisual content as described above. Other features and advantages of the invention will appear more clearly and concretely on reading the following description of embodiments, and with reference to the appended drawings.

### BRIEF DESCRIPTION OF THE DRAWINGS

FIG. 1 schematically illustrates a video image of an audiovisual content;

FIG. 2 schematically illustrates a background of the video image;

FIG. 3 schematically illustrates objects of interest of a foreground of the video image;

FIG. 4 schematically illustrates steps of a method for producing visual immersion effects according to various embodiments;

FIG. 5 schematically illustrates the stimulation of peripheral vision during the projection of an audiovisual content according to various embodiments;

FIG. 6 schematically illustrates modules involved in the production of visual immersion scripts according to various embodiments.

### DETAILED DESCRIPTION

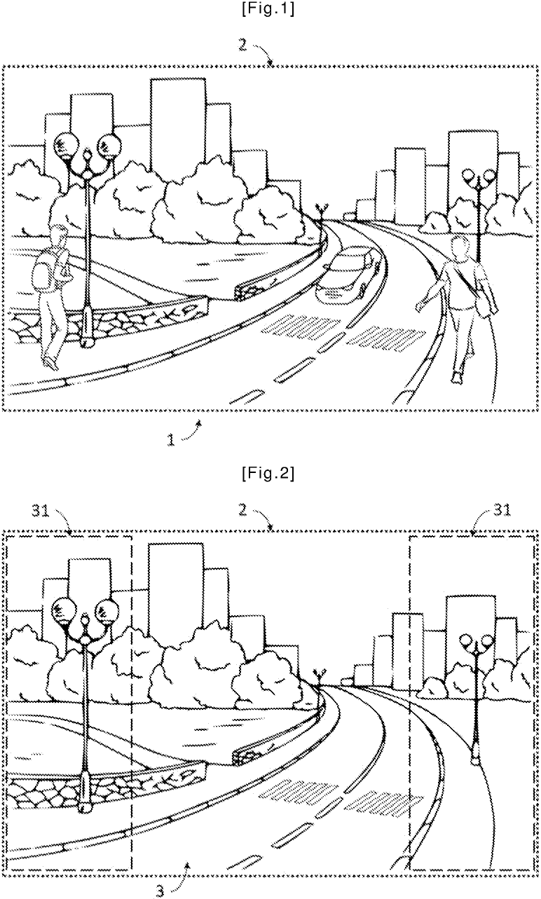

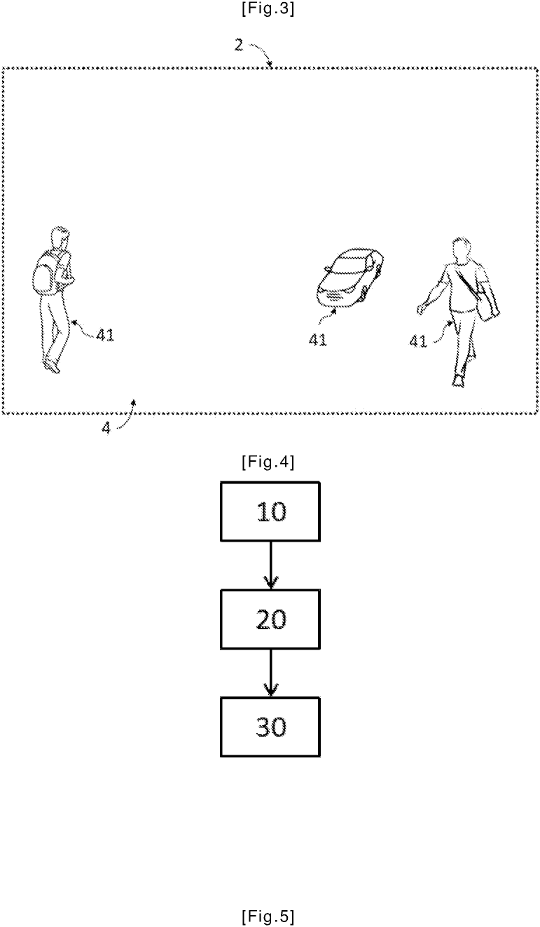

Referring to FIG. 1, a video image 1 of an audiovisual content is being displayed on a screen 2 arranged facing the viewer. This audiovisual content is, for example, a cinematographic work, or a video film intended to be displayed/projected on a display screen arranged on a wall at the front of a cinema.

The video image 1 comprises a background 3 (or a setting) and a foreground 4. The background 3 corresponds to the scene, the decor or the environment in which one or more object 41 in the foreground are located or are in movement. The foreground 4 comprises objects 41 of interest present or in action in the environment represented by the background 3. A background 3 is, indeed, generally indexed on the presence of at least one object 41 or a subject, referred to as of interest, in the foreground on which it is expected that the viewer’s attention will focus. In the absence of object 41 in the foreground, the entire content of the video image 1 can, in one embodiment, be considered to be the background 3.

Splitting up or segmentation of the content of a video image 1 into a background 3 and a foreground 4 can be obtained by any method known in the art allowing extraction of the background 3 and/or of the foreground 4. These methods include, for example, background (or, equivalently, foreground) subtraction methods, object extraction methods, methods for searching for contours in motion (optical flow computation or block-matching for example), or methods based on deep learning. In one embodiment, the extraction of the foreground 4 and/or of the background 3 of the video image 1 comprises a step of comparing this video image 1 to the preceding and/or subsequent video images of the audiovisual content.

In one embodiment, the extraction of a background 3 and/or of a object 41 in the foreground of the video image 1 is based on the psychology of shapes (better known as Gestalt theory) applied to the visual perception of the viewer. When perceiving the video image 1, the viewer isolates a portion that becomes an object 41 in the foreground on which the viewer’s attention gets focused, and a remainder of the video image 1 becoming a background 3. The background 3 is relatively undifferentiated by the viewer and which appears to the viewer to extend (by a subjective localization effect) under the object 41 in the foreground beyond the contours that limit them or portions thereof. This distinction results from the application of one or more laws of Gestalt theory such as
the proximity law according to which the closest elements in a video image 1 are considered to be perceived by the viewer as belonging to a same group of the foreground 4 or of the background 3;
the similarity law according to which elements having the highest graphical similarities (shape, color, orientation for example) in a video image 1 are assumed to induce in the viewer an identical meaning, similar functions or a common importance;
the continuity law according to which the greater the proximity of certain visual elements in the video image 1, the more they are perceived by the viewer, with continuity, as if they are part of a same grouping of the background 3 or of the foreground 4;
the law of common fate according to which objects moving along a same trajectory are perceived by the viewer as being part of a same grouping of the foreground 4 or of the background 3.

Thus, the video image 1 is decomposed into a foreground 4 and a background 3 (or a setting 3). More generally, a foreground 4 and a background 3 are associated with each video image 1 of the audiovisual content.

End regions (or a region) 31 are selected from the background 3 of the video image 1. In the example of FIG. 2, these end regions 31 are two regions located at the lateral (right and lefthand) ends of the background 3. In combination or alternatively, these end regions 31 may comprise a lower end region and/or an upper end region of the background 3.

An end region 31 is, in one embodiment, a strip extending from an edge of the background 3 towards its center up to a predefined distance. In another embodiment, an end region 31 of the background 3 has a generally rectangular shape that covers an edge region of the background 3 or, generally, a region comprising an edge of the background 3. The dimensions and/or the shape of an end region 31 may be fixed or variable from one video image 1 to another.

In one embodiment, a first end region 31 and a second end region 31 located, respectively, at a first end and an opposite second end of the background 3 (left and righthand and/or lower and upper for example) are selected. The selected end regions 31 of one and the same background 3 may be of different shape and/or dimensions. In one embodiment, two opposite end regions 31 of a background 3 have the same shape and/or the same dimensions. In another embodiment, the selection of a plurality of end regions 31 located at the same end of a same background 3 and being of different shapes and/or dimensions may be envisaged. For example, when the size of the background 3 (or equivalently, of the video image 1) is 2048x1152, a first left-end region 31 of 0 to 360 pixels by 858 lines and a second right-end region 31 of 1688 to 2048 by 858 lines are selected.

Image processing is applied to each selected end region 31 of the background 3 to generate visual frames intended to be displayed in the viewer’s peripheral field of view during the projection of the video image 1 into the central field of view of the viewer. This image processing comprises the application of graphic effects, cutting, cropping (or trimming) operations, non-proportional resizing, and/or geometric transformations (or deformations).

By way of non-exhaustive examples, the graphic effects, generally implemented by means of parameterizable filters, comprise
blurring effects such as soft focus (of the Bokeh type, motion blur, or camera shake), depth of field blur (or background blur), a directional blur, radial blur, a Gaussian blur, or a composite blur;
sharpness effects such as the adaptation of color depth, of resolution, of definition and/or or emphasis;
colorimetric effects making it possible to adapt, for peripheral vision, for example, color shade, brightness/darkness, color saturation, central color, the correspondence between colors, color temperature, the texture, color balance, chromatic replication (or mean RGB replication), and/or the curves/histograms for colors of the selected region;
a modification of the brightness of at least one color by adapting contrast, the histogram or the curve for brightness, white balance, shadows, or the degree of brightness/darkness.

In one embodiment, image processing comprises an adjustment of the colorimetric ambience (via the color balance, or a three-directional chromatic corrector for example) of the selected end region 31. For this purpose, colorimetric effects are applied to the selected end region 31 so as to generate a visual frame having a certain colorimetric ambience. The term colorimetry is understood here to mean the general hue which one perceives from a visual frame. This colorimetric ambience is, for example, dominantly, a predefined color.

In one embodiment, the image processing applied to the selected end region 31 comprises a restitution of the average colorimetric ambience (or average RGB color, i.e. the mean of each of the Red, Green, Blue) components of:
this first selected end region 31, or
the background 3 of the video image 1, or
the background 3 of the video image 1 and the background of a video image following and/or preceding the video image 1 in the audiovisual content; or
the selected first end region 31 and a corresponding first end region 31 selected from the background of a video image following and/or preceding the video image 1 in the audiovisual content.

In one embodiment, the image processing applied to an end region 31 is correlated or linked to a sound content of the audiovisual content. This image processing is, for example, linked to a semantic state and/or to a sound parameter of a sound content associated with the video image 1. A semantic state and/or a sound parameter are therefore determined for a sound content associated with the video image 1.

A semantic state of a sound content is a semantic description (or a description of the meaning) of a sound segment. Sound content is able to carry a lot of semantic information. This semantic state is, for example, a meaning assigned to the sound content or an expression of feelings/emotions such as joy, sadness, anger, fear, an encouragement or, more generally, any event of audio interest. This advantageously results in a visual interpretation of the semantic state of the audio space of the audiovisual content.

A semantic state of a sound content is, in one embodiment, determined following a semantic classification, according to predefined taxonomies, based on sound objects (musical extract, laughter, applause, speech, a cry for example) of this sound content and/or a textual description of the sound content (a transcription of speech for example). In one embodiment, the semantic classification of the sound content is, furthermore, based on a semantic classification of visual objects in the video image 1, in particular the recognition of a visual object in the background 3 and/or an object 41 in the foreground. The recognition of a visual object in the video image 1 advantageously makes it possible to estimate the source of the sound content and/or the sound context of video image 1 and, consequently, improve the determined semantic state of the sound content.

In one embodiment, an image processing applied to a selected end region 31 comprises a setting of its colorimetric ambience as a function of the determined semantic state of the sound content associated with the video image 1. For example, this colorimetric ambience is dominantly the color pink when the determined semantic state is romantic, or the color white when the determined semantic state is happiness or joy. The sound parameter is, in one embodiment, chosen from the physical parameters of the sound content integrating a pitch of the sound (low pitched/high pitched sound or, more generally, a frequency), a sound duration (a short/long sound), a sound intensity (or volume), timbre, and/or a sound directivity.

By way of illustration, image processing comprises the application of a graphic effect correlated to the sound intensity and/or to the sound duration of a sound segment associated with the video image 1 being projected. This image processing is, for example, a lighting effect or, generally, a modification of the brightness of at least one color in the selected end region 31. In one embodiment, the image processing applied comprises a modification of the degree of brightness of at least one color of the end region 31 selected in proportion to the sound intensity. This makes it possible, for example, to translate a burst of sound or a short high intensity sound (of a detonation, a gunshot or an explosion for example) by a high-brightness visual frame.

In another example, the image processing comprises a setting of the colorimetric ambience correlated to the pitch and/or to the timbre of a sound content associated with the video image 1 being projected. This image processing is, for example, a colorimetric ambience setting for a visual representation of a musical sound (a melody, a rhythm, a harmony, or some musical instrument for example) or a voice (male or female voice).

The image processing applied can also take account of the sound directivity of the sound associated with the video image 1, including in particular orientation with respect to the viewer of the visual object assumed to be the source of this sound and/or how far it is away (its intensity). This advantageously results in a visual display or interpretation of the sound space of the audiovisual content.

By combining and/or varying one or more image processes applied to an end region 31 (resizing, filters, intensity, direction or, more generally, one or more parameters of image processing), a plurality of visual frames may be generated for a same selected end region 31 of a background 3. A non-proportional resizing of the height and/or the width of the end region 31 makes it possible to stretch them so as to best cover the viewer’s peripheral field of view.

In order not to expose the viewer’s peripheral vision to significant stimulations which could cause him or her to turn their head and thus lose the sense of immersion, a visual frame is, in one embodiment, of low contrast, of low resolution and less sharp than the end region 31 from which this visual frame is generated. Generally, insofar as the generated visual frames are intended for the activation of peripheral vision, the image processing applied to a selected end region 31 of a background 3 comprises a reduction in sharpness below a predefined threshold. As a result of the image processing applied to an end region 31, the generated visual frame comprises one or more indices of the environment at the selected end region 31 (its colorimetry, luminance, look, general shape, and/or the general appearance of the objects present in this end region 31), without however describing it in detail.

Display of a visual frame deduced from the video image 1 makes it possible to extend or prolong, in the viewer’s peripheral field of view at least partially, the background 3 of the video image 1 being projected into the viewer’s central field of vision. Extension of the background 3 - which constitutes a point of reference for the viewer in the video image - into the peripheral visual field produces an impression of depth in video image 1. Indeed, by stimulating peripheral vision, the latter acts as a vector adding perspective that promotes a perception of depth and, consequently, the production of a sensation of visual immersion for the viewer.

During the projection of the video image 1 in the central field of view of the viewer, the visual frame presents indices of the background of the video image 1 to the viewer’s peripheral vision without however diverting the viewer’s attention from the front-end screen 2. As a result, advantageously, the visual frame makes it possible to extend the spatial points of reference displayed in the video image 1 to the effect of better still bringing the viewer’s attention to foreground objects 41 and providing the viewer with a sense of immersion in video image 1.

Advantageously, the visual frame does not include indices of objects 41 in the foreground which remain displayed only in the central field of view of the viewer. The background 3 is extended by these ends to also cover the peripheral field of view, while the objects 41 in the foregrounds remain associated with central vision. Occupying the visual field of the viewer advantageously makes it possible to encompass the viewer in the environment of the video image 1 being projected in the viewer’s central field of view and to make the viewer’s attention converge on the screen at the front 2.

The result is, for the viewer, an immersive decomposition of the video image 1 in which
foreground objects 41 (i.e., objects 41 of interest) are presented to the viewer’s central vision and, therefore, to the viewer’s direct analysis; and
the decor or the environment (in other words the background 3) extends beyond the viewer’s central visual field to also fill the viewer’s peripheral visual field.

Each visual frame is intended to be displayed in the viewer’s peripheral field of view on the same side as the end region 31 from which this visual frame is generated. In other words, each visual frame is intended to occupy a region of the peripheral visual field of the viewer. This region diverges from the end region 31 from which the visual frame is generated.

In another embodiment, the visual immersion induced by the activation of peripheral vision by means of the visual frames is further amplified by means of ambient light. This ambient light is emitted by at least one light source capable of emitting a beam of light in a predetermined direction. In one embodiment, the hue or color temperature of the emitted beam of light is adjustable. This light source is, for example, a spotlight, or a directional projector.

The emitted ambient light aims to reproduce a beam of light present in the video image 1 which is being projected (flashlight effect). The beam of light present in the video image 1 may correspond to an illumination by a directional light source such as a flashlight, or automobile headlights. To do this, analysis of the foreground objects 41 makes it possible to detect the presence of a beam of light in the projection video image 1. This detection is, in one embodiment, based on deep machine learning. Alternatively, or in combination, this detection may be based on the shape and/or the brightness of the object 41 in the foreground.

The control of the ambient light is determined by the direction and the hue of the beam of light detected in the foreground 4 of the projection video image 1. It is thus possible to reproduce the evolution in successive video images 1 of a beam of light being produced, for example, by the headlights of a motor vehicle negotiating a bend in the road or by a flashlight being manipulated by someone. In one embodiment, the beam of light is reproduced in the vertical peripheral field of view (in particular, above the central field of view) of the viewer. The application of the processing described above to all the video images 1 of the audiovisual content makes it possible to produce a library of visual immersion effects. This library of visual immersion effects comprises, for each video image 1, one or more visual frames, correlated or not to the soundtrack, and optionally control data for a light source.

This visual immersion effect library constitutes a resource for the creation of a visual immersion script for the audiovisual content. This visual immersion script comprises a series of visual frames and control data for a light source consistent with the initial audiovisual content and intended to be displayed in the viewer’s peripheral field of view during the projection of the audiovisual content.

Indeed, by associating one or more visual frames and, optionally, ambient light with each video image 1 of the audiovisual content, various visual immersion scripts can be created from this library of visual immersion effects for the same initial audiovisual content. Each of these visual immersion scripts is, advantageously, generated natively from the initial source, namely the film or more generally the audiovisual content. This makes it possible to maintain a creative consistency between the choices of the effects constituting the visual immersion script and the initial audiovisual content in the viewer’s visual and audible narrative. A visual immersion script can thus be added to the initial audiovisual content without deformation of the initial work.

In one embodiment, a visual immersion script is automatically generated from the visual immersion effect library. For this, a software application (or, generally, a computer program product) is configured to associate one or more visual frames and, optionally, control data for ambient light deduced from this video image 1 with each video image. In order to maintain a coherent impression throughout this visual immersion script, the software application is further configured to guarantee a correlation coefficient between two successive visual frames (intra-frames) greater than a first predefined threshold value. This software application is, in another embodiment, configured to choose from the visual frames associated with a video image 1, one or more visual frames each having, with the end region 31 from which this visual frame is generated, a correlation coefficient greater than a second predefined threshold value.

This software application is, in another embodiment, also configured to generate, from the audiovisual content, the library of visual immersion effects. In one embodiment, this software application is integrated into a graphical creation business software environment. The software application is, in one embodiment, able to produce a visual immersion script intended to be displayed in the viewer’s peripheral field of view in real time (in other words on the fly) from an audiovisual content being projected (in particular, a film) at the same time as the projection of the audiovisual content in the central field of view of this viewer.

In one embodiment, a home theater system (commonly known as home cinema) or, more generally, a television system comprises the software application or a device implementing this software application. This home cinema system comprises at least a first video output and a second video output arranged to provide a visual immersion script. This visual immersion script is produced in real time by the software application from the audiovisual content being projected on a screen at the front. This visual immersion script is intended to be displayed on at least two side screens on either side of the screen at the front. The side screens are, in one embodiment, arranged on the side walls of a room.

Referring to FIG. 4, the production, from a given audiovisual content, of visual immersion effects comprises, as described above, a step of distinguishing, for each video image 1 or video shot of this audiovisual content, a background 3 (or setting) and a foreground 4. This distinction can result from the extraction of the background 3 (step 10) or of the foreground 4. At least one end region 31 located at one end of the extracted background 3 is selected (step 20). Preferably, two end regions 31 located at two opposite ends, in particular lateral ends, of the extracted background 3 are selected.

The application (step 30) of a predefined image processing to a selected end region 31 makes it possible to generate at least one visual frame intended to be displayed into the peripheral field of view of a viewer during the projection of the video image 1 into the central field of view of the viewer. This image processing adapts the graphical content of the end region 31 to the viewer’s peripheral vision (in terms of sharpness, colorimetry, brightness, contrast, or dimensions, for example). This image processing is, in one embodiment, linked to the sound content (in its semantic and/or physical dimension) associated with the video image 1 of the audiovisual content. The visual frames thus generated are intended to be displayed/projected onto screens addressing the viewer’s peripheral vision.

Moreover, the extraction of the foreground 4 makes it possible to detect a beam of light therein which, to the effect of visual immersion, can be reproduced in the viewer’s peripheral field of view. For this purpose, the direction of this beam of light with respect to a predefined direction is determined. The hue or the color temperature of this beam of light are, in one embodiment, also determined. Control data for a predefined light source for emitting, in the viewer’s peripheral field of view, a beam of light in the determined direction or in a direction associated with the determined direction are subsequently generated.

By arranging visual frames and the control data thus generated, a visual immersion script for the audiovisual content can be produced. This visual immersion script can be used in a movie theater 5, as illustrated in FIG. 5. This movie theater 5 comprises a screen at the front 2 and a plurality of side screens 7 on either side of the screen at the front 2. The screen at the front 2 has an aspect ratio able to cover the central visual field 8 of a member of the audience 6. As for the lateral screens 7, they are arranged on the lateral faces of the movie theater 5 and are intended to fill the peripheral field of view 9 of a member of the audience 6. Screens at the ceiling and/or the floor of the movie theater 5 (not shown in FIG. 5) can be envisaged to cover the vertical peripheral visual field of the viewer. More generally, any screen making it possible to at least partially fill the peripheral field of view 9 (horizontal and/or vertical) of a viewer placed facing the screen at the front 2 can be envisaged. In one embodiment, the lateral screens 7 are LED panels.

A plurality of light sources 71 capable of emitting a beam of light are arranged above the lateral screens 7, and/or above the screen at the front 2, at the ceiling, and/or at the bottom of the movie theater 5 (behind the audience). The display of the visual frames of the visual immersion script on the lateral screens 7 allows an extension or a prolongation of the background of the video image 1 being projected on the screen at the front 2 into the peripheral field of view 9 of a member of the audience 6. This produces in the viewer 7 the impression that the background of the video image 1 being projected on the screen at the front 2 extends into the lateral screens 7 which encompasses it in this video image (a surrounding and immersive effect).

The projection (or display) of the audiovisual content on the screen at the front 2 and, simultaneously, the visual immersion script on the lateral screens 7 creates an immersion space allowing a member of the audience 6 to be immersed in the environment of the scene perceived in the video image 1 being projected on the screen at the front 2. A member of the audience 6 keeps his or her central gaze on the screen at the front 2, while remaining aware of what is being offered to the viewer’s peripheral vision by the lateral screens 7 (comprising, in particular, indices of the environment of the video image 1 being projected). The visual frames comprise visual information provided in the peripheral field of view 9 of a member of the audience 6, deduced from the sound content and the video images and shots of the audiovisual content, in order to activate/excite the viewer’s peripheral vision, without diverting the viewer’s attention from the screen at the front 2.

In one embodiment, the immersion script comprises, for one and the same video image 1, a plurality of visual frames intended to be displayed on a plurality of lateral screens 7 arranged on the same lateral face of the movie theater 5. These visual frames take into account the where the member of the audience 6 is sitting inside the movie theater 5 (in the first row, in the middle, or at the back of the movie theater for example). In another embodiment, these visual frames are increasingly blurred in a direction away from the screen at the front 2 in order to take account of the fact that going from the central region to the peripheral region of the field of view is a continuum between sharpness and blur and not a blunt transition. As an alternative, a visual frame is segmented into as many lateral screens 7, the frame being less and less sharp moving away from the screen at the front 2. The number, the dimensions and/or the arrangements of the lateral screens 7 are chosen so as to bring the edges of the visual frames close to the edges of the visual field of the audience 6 and leave as little space as possible for the actual space in the viewer’s field of view.

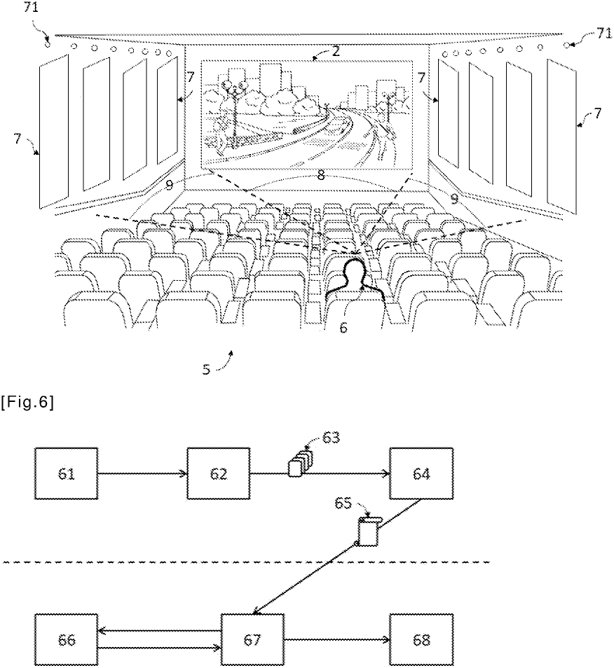

Referring to FIG. 6, modules involved in the production of a visual immersion script 65 for audiovisual content 61 are illustrated. For this purpose, the audiovisual content 61 is firstly inputted into a generator 62 of visual frames implementing the method described above. Preferably, a plurality of different visual frames is generated for each video image of the audiovisual content 61 so as to obtain as an output a palette 63 of immersive effects. Based on this palette 63 of immersive effects, a visual immersion script generator 64 is able to produce one or more visual immersion scripts 65.

Following this, when the audiovisual content 61 is read by a multimedia player 66 (a software reader or a projector for example), the visual immersion script 65 is simultaneously played by an immersion script reader 67 via one or more media 68 such as LED panels, a virtual environment in 3D simulation, or display screens. The palette 63 of immersive effects is, in one embodiment, constructed well upstream of the projection of the audiovisual content 61 by the multimedia player 66, giving time to be able to generate several different visual immersion scripts 65.

To ensure synchronous playback of the audiovisual content 61 and the visual immersion script 65, synchronization information is exchanged between the multimedia player 66 and the immersion script reader 67. In one embodiment, the immersion script reader 67 is separate from the multimedia reader 66 so that it does not access the audiovisual content 61 being shown.

Advantageously, the embodiments described above make it possible to go beyond the two-dimensional display for the screen at the front 2 by extending the environment/background of the video image 1 being projected outside this frame so as to activate the viewer’s peripheral vision who, therefore, has the impression of being in the image (a sense of presence) and not facing a projection onto a flat surface not conducive to immersion. By being a carrier of meaning, visual interpretation of the sound content makes it possible to further improve the feeling of immersion for the viewer. In addition, imitating a beam of light present in the video image being projected in the viewer’s peripheral field of view makes it possible to further enrich the immersive experience of the viewer.

1-16. (canceled)

17. A method for producing visual immersion effects for audiovisual content integrating a video image and sound content associated with the video image the method comprising:
extracting a background from the video image;
selecting a first end region located at a first end of the extracted background;
determining a semantic state of the sound content;
applying a predefined image processing to the selected first end region to generate at least one visual frame intended to be displayed in a peripheral field of view of a viewer during the projection of the video image into the central field of view of the viewer, wherein the predefined image processing is related to the determined semantic state of the sound content.

18. The method according to claim 17, further comprising determining a sound parameter from the sound content, the predefined image processing being related to the sound parameter determined from the sound content.

19. The method according to claim 18, wherein the sound parameter is chosen from a list comprising a pitch of the sound, a sound duration, a sound intensity, a timbre of the sound, and/or a sound directivity.

20. The method according to claim 17, wherein the predefined image processing comprises setting a colorimetric ambience of the selected first end region.

21. The method according to claim 20, wherein the predefined image processing comprises restituting an average of the colorimetric ambience of the first selected end region.

22. The method according to claim 17, wherein the predefined image processing comprises changing the brightness of at least one color in the selected first end region.

23. The method according to claim 17, wherein the predefined image processing comprises applying a blurring effect.

24. The method according to claim 17, further comprising:
selecting a second end region located at a second end of the extracted background, the second end being opposite the first end; and
applying the predefined image processing to the selected second end region.

25. The method according to claim 17, wherein a plurality of different visual frames integrating the at least one visual frame is generated from the first end region.

26. The method according to claim 17, further comprising:
extracting a foreground from the video image;
detecting a beam of light in the extracted foreground;
determining a direction of the detected beam of light; and
generating control data for controlling a light source adapted to generate a beam of light in a direction associated with the determined direction.

27. The method according to claim 17, further comprising generating a visual immersion script integrating the visual frame.

28. The method according to claim 27, wherein the visual immersion script further comprises control data for a light source.

29. The method according to claim 28, wherein the control data is interpretable by a script reader in any form be it software, hardware, firmware or a combination of these forms.

30. The method according to claim 27, further comprising adding the visual immersion script to the audiovisual content.

31. The method according to claim 28, further comprising adding the visual immersion script to the audiovisual content.

32. The method according to claim 27, further comprising reading out the visual immersion script in a virtual environment in 3D simulation.

33. The method according to claim 28, further comprising reading out the visual immersion script in a virtual environment in 3D simulation.

34. The method according to claim 29, further comprising reading out the visual immersion script in a virtual environment in 3D simulation.

35. A computer program product implemented on a memory medium, capable of being implemented within a computer processing unit and comprising instructions for implementing a method for producing visual immersion effects for audiovisual content, the computer program product being configured to:
extract a background from a video image;
select a first end region located at a first end of the extracted background;
determining a semantic state of a sound content;
apply a predefined image processing to the selected first end region to generate at least one visual frame for display in a peripheral field of view of a viewer during the projection of the video image into a central field of view of the viewer; and
the predefined image processing being related to the determined semantic state of the sound content.
